(19) United States
(12) Patent Application Publication
(10) Pub. No.: US 2019/0195013 A1
(43) Pub. Date: Jun. 27, 2019

(54) FLEXIBLE AND FORCE-VARIABLE CURTAIN FABRIC RETRACTABLE DEVICE

(71) Applicants: YIJUN WAN, SHENZHEN (CN); XINCHENG WAN, SHENZHEN (CN)

(72) Inventors: YIJUN WAN, SHENZHEN (CN); XINCHENG WAN, SHENZHEN (CN)

(73) Assignee: SHENZHEN KANGER WINDOWS DECORATION CO., LTD., SHENZHEN (CN)

(21) Appl. No.: 15/991,571

(22) Filed: May 29, 2018

Related U.S. Application Data
(63) Continuation-in-part of application No. 15/903,929, filed on Feb. 23, 2018.

(30) Foreign Application Priority Data
Dec. 22, 2017 (CN) 201711404316.7
Dec. 25, 2017 (CN) 201721844698.0

(51) Int. Cl. E06B 9/60; E06B 9/17; E06B 9/44

(52) U.S. Cl. CPC E06B 9/60; E06B 2009/587; E06B 9/44; E06B 9/17007

(57) ABSTRACT

The present invention discloses a flexible and force-variable curtain fabric retractable device, including a hollow metal rod for wrapping a curtain fabric and a fixing mounting member mounted on both left and right ends of the hollow metal rod, wherein one end of the hollow metal rod is inlaid and installed with a flexible force-variable elastic structure, and the other end of the hollow metal rod is inlaid and installed with a driven structure, both ends of the hollow metal rod are rotatably connected with a fixing mounting member through a flexible force-variable elastic structure and a driven structure respectively.

### FIELD OF THE INVENTION

The present invention relates to the technical field of curtain retractable device, in particular to a flexible and force-variable curtain fabric retractable device.

### BACKGROUND

Traditional curtains are pulled or retracted manually, which are very inconvenient; in addition, in the prior art, devices used to automatically control the retraction of curtains have low stability and sensitivity, and the retractable structure occupies a large space, so that users cannot achieve free assembly according to different size; moreover, they are difficult to disassemble, with high processing cost.

### SUMMARY

The present invention provides a flexible and force-variable curtain fabric retractable device that addresses the problems of the prior art.

In order to solve technical problem presented in prior art, one embodiment of the present invention adopts the following technical solutions:

A flexible and force-variable curtain fabric retractable device, including a hollow metal rod for wrapping a curtain fabric and a fixing mounting member mounted on both left and right ends of the hollow metal rod, wherein a first end of the hollow metal rod is inlaid and installed with a flexible force-variable elastic structure, and a second end of the hollow metal rod is inlaid and installed with a driven structure, both ends of the hollow metal rod are rotatably connected with a fixing mounting member through a flexible force-variable elastic structure and a driven structure respectively; the flexible force-variable elastic structure includes a central shaft, a spring mounting base and a volute spiral spring, a first end of the central shaft is detachably mounted with a fixing mounting member, a spring mounting base is rotatably inserted on a central shaft, and at least one spring mounting groove are disposed on the spring mounting base, the volute spiral spring is installed in the spring mounting groove, a central end of the volute spiral spring is connected with the central shaft, and a free end of the volute spiral spring is in contact with an inner wall of the hollow metal rod.

Wherein, the driven structure is a plastic plug connector with ribs protruding outwardly, the plastic plug connector is transversely inserted into the hollow metal rod; a rotating cylinder is protrudingly disposed on the plastic plug connector's side connected with the fixing mounting member, a circular hole is correspondingly disposed at the fixing mounting member's center, and the rotating cylinder is inserted into the circular hole.

Further, a limiting notch is provided on the plastic plug connector for preventing self-rotation, and a limiting bar matching with the limiting notch is provided inside the hollow metal rod, a limiting slot matching with the limiting bar is provide on the spring mounting base; a curtain fabric insertion slot is formed between the limiting bar and the hollow metal rod, and an elongated opening is provided on the hollow metal rod corresponding to the curtain fabric insertion slot for the curtain fabric to pass through.

Wherein, two spring mounting grooves are juxtaposed on the spring mounting base, said two spring mounting grooves are formed by three partition plates; a outer side of each of the partition plate is provided with a transverse connecting plate, and the three partition plates are connected with the spring mounting base integrally through a transverse connecting plate.

Wherein, a strip hole is radially opened on the central shaft, and the central end of the volute spiral spring is snapped and fixed into the strip hole.

Further, a cross-shaped insertion slot is provided at one end of the central shaft connected to the fixing mounting member, and a “ [symbol] ” shaped plug piece is provided inside the fixing mounting member, and through mutually connecting the cross-shaped insertion slot and the “ [symbol] ” shaped plug piece, the central shaft is connected and assembled with the fixing mounting member.

Wherein, a fixed top plate made of aluminum is provided at the top of two fixing mounting members, the fixed top plate is provided with a rectangular insertion slot, the fixing mounting member is provided with a plug plate corresponding to the rectangular insertion slot, by inserting the plug plate into the rectangular insertion slot, the fixed top plate is assembled with the fixing mounting member at both ends to form a “ [symbol] ” shaped mounting base.

Yet another embodiment of the present invention comprises the curtain fabric retractable device, including the hollow metal rod for winding the curtain fabric, the first end of the hollow metal rod is provided with the fixing mounting member, and the second end is provided with a rotating control structure based on the contraction and release of the volute spiral spring. The hollow metal rod can be installed between the fixing mounting member and the rotating control structure through rotation. The rotating control structure includes a control mechanism shell, in which a rotating wheel driven by the hollow metal rod, the central shaft and the volute spiral spring installed on the central shaft are installed. The central shaft is located below the rotating wheel, and a tail end of a outermost ring of the volute spiral spring is connected to a first side of the rotating wheel.

Wherein the fixed top plate is further arranged between the fixing mounting member and the rotating control structure. The control mechanism shell includes a left shell and a right shell. A first side of the left shell is connected to the fixed top plate as a combination, and a second side is combined with the right shell as a holding space; a locating column and a fixed connecting column that are used to install the rotating wheel and the central shaft are arranged on the right shell, and the locating column and the fixed connecting column are integrated with the right shell as an organic whole.

Further, a rectangular slot is arranged on the fixed top plate, and a plug plate used to cooperate with the rectangular slot for installation is arranged on the fixing mounting member and the left shell respectively.

Wherein the plastic plug connector is inserted into a first side of the hollow metal rod that is connected to the fixing mounting member, the rotating cylinder is arranged on the bulge of the plastic plug connector, the circular hole is arranged correspondingly at the center of the fixing mounting member, and the rotating cylinder is inserted into the circular hole.

Further, a plug stiffener that fits the inner wall of the hollow metal rod is formed on a outer wall of the plastic plug connector, and the limiting notch for preventing autorotation is arranged on the plastic plug connector; and the limiting bar that fits the limiting notch is arranged inside the hollow metal rod.

Wherein the curtain fabric insertion slot is formed between the limiting bar and the hollow metal rod, and a strip-shaped opening is arranged at the position on the hollow metal rod that corresponds to the curtain fabric insertion slot for curtain fabric to pass through.

Wherein a square hole for connecting the hollow metal rod is arranged in the middle of the rotating wheel, a second plastic plug connector is inserted into a second side of the hollow metal rod to be connected to the rotating wheel, a square connecting block is arranged on the bulge of the second plastic plug connector, and the square connecting block is inserted into the square hole.

Beneficial Effects:

The invention provides a flexible and force-variable curtain fabric retractable device, including a hollow metal rod for wrapping a curtain fabric and a fixing mounting member mounted on both left and right ends of the hollow metal rod, wherein one end of the hollow metal rod is inlaid and installed with a flexible force-variable elastic structure, and the other end of the hollow metal rod is inlaid and installed with a driven structure, both ends of the hollow metal rod are rotatably connected with a fixing mounting member through a flexible force-variable elastic structure and a driven structure respectively. By simply pushing or pulling the curtain fabric to generate proper power, the volute spiral spring generates deformation to exert a pressing force on the hollow metal rod, and the hollow metal rod can rotate quietly and softly, and stop the intended position accurately, stably and easily without any rebound. The invention can realize the retraction of the curtain fabric by directly pulling the end of the curtain fabric by hand, without requiring the setting of a hand pulling cord or an electric lifting structure; in addition, some parts of the flexible force-variable elastic device and hollow metal rod can be selected or replaced according to the requirements, with high production efficiency, low cost and better cost performance.

### BRIEF DESCRIPTION OF THE DRAWINGS

FIG. 1 is a schematic structural view of the overall structure of one embodiment of the present invention.

FIG. 2 is an exploded view of one embodiment of the present invention.

FIG. 3 is a schematic structural view of a combination of a central shaft and a spring mounting base of one embodiment of the present invention.

FIG. 4 is a schematic structural view of a plastic plug connector of one embodiment of the present invention.

FIG. 5 is a schematic structural view of a hollow metal rod of one embodiment of the present invention.

FIG. 6 is a structural decomposition diagram of yet another embodiment of the present invention.

FIG. 7 is an exploded view of the rotating control structure of yet another embodiment of the present invention.

FIG. 8 is a structural schematic diagram of the plastic plug connector of yet another embodiment of the present invention.

Notes of attached drawings: 1—hollow metal rod; 2—fixing mounting member; 3—central shaft; 4—spring mounting base; 5—volute spiral spring; 6—spring mounting groove; 7—circular hole; 8—partition plate; 9—transverse connecting plate; 10—limiting bar; 11—limiting slot; 12—strip hole; 13—cross-shaped insertion slot; 14—fixed top plate; 15—plug plate; 16—plastic plug connector; 17—rotating cylinder; 18—limiting notch; 19—curtain fabric insertion slot; 20—left shell; 21—right shell; 22—rotating wheel; 23—square hole; 24—locating column; 25—fixed connecting column; 26—rectangular slot; 27—plug stiffener.

### DETAILED DESCRIPTION

For the understanding by those skilled in the art, the present invention is further described in combination with embodiments and accompanying drawings. The contents mentioned in the embodiments are not intended to limit the present invention. The present invention is described in details with reference to the accompanying drawings.

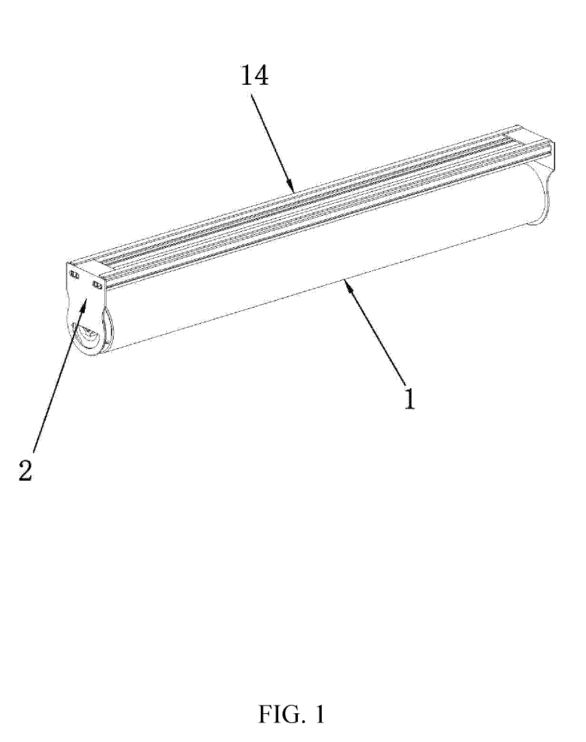

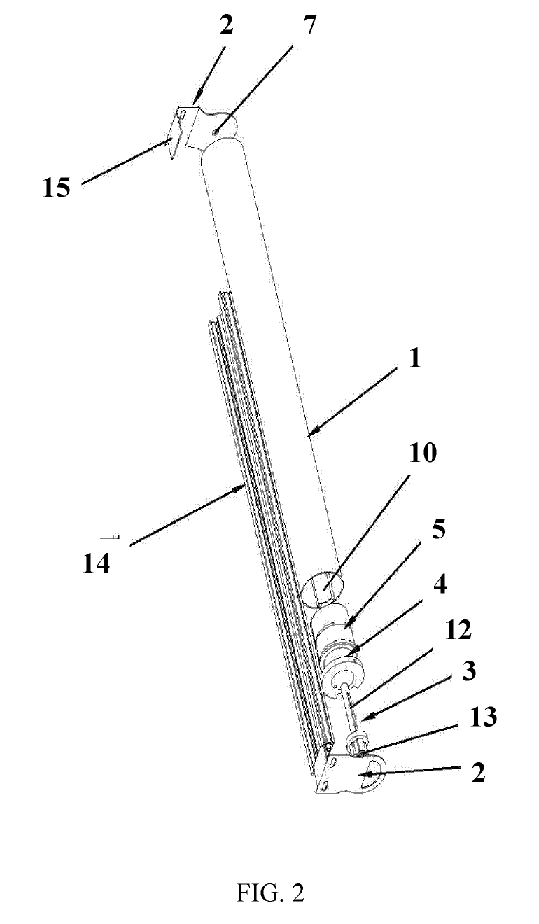

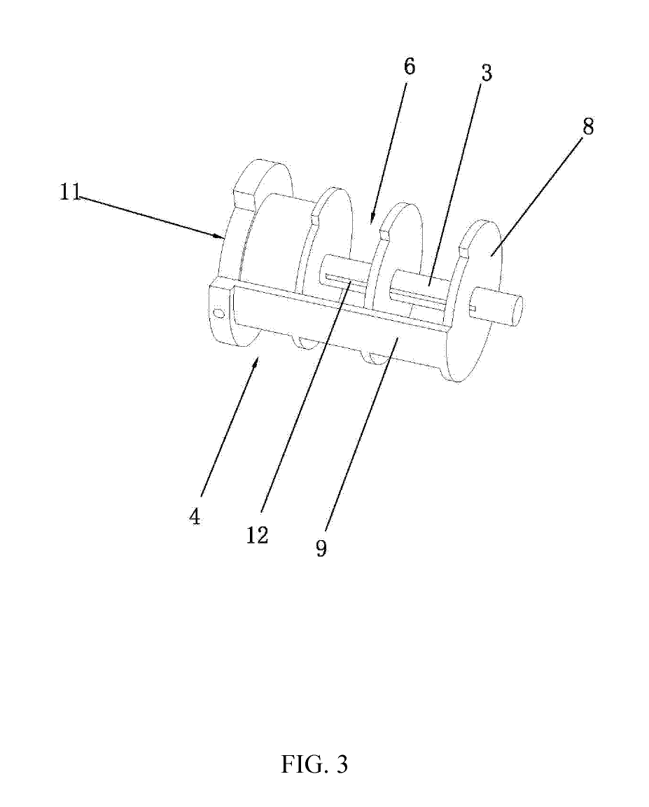

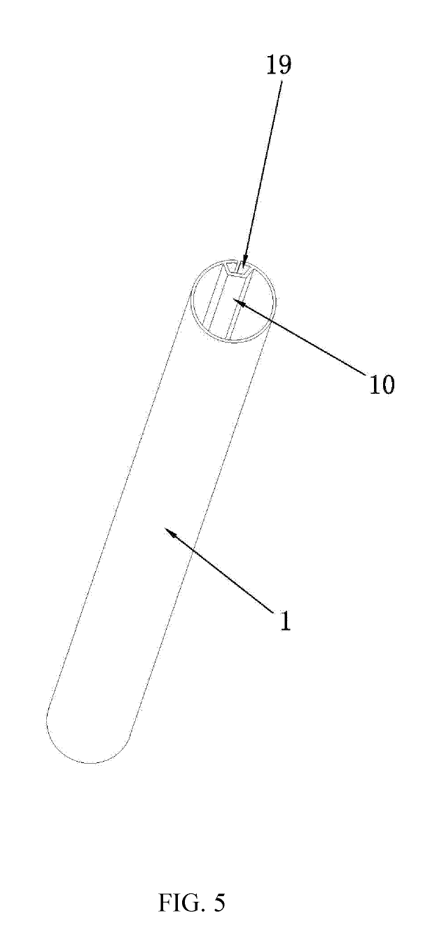

One embodiment of the present invention is described in FIGS. 1 to 5 and further described in details herein. Said embodiment provides a flexible and force-variable curtain fabric retractable device, including a hollow metal rod 1 for wrapping a curtain fabric and a fixing mounting member 2 mounted on both left and right ends of the hollow metal rod 1, when in use, fixing mounting member 2 can be directly mounted at the top of the window with screws; a first end of the hollow metal rod 1 is inlaid and installed with a flexible force-variable elastic structure, and a second end of the hollow metal rod 1 is inlaid and installed with a driven structure, both ends of the hollow metal rod 1 are rotatably connected with a fixing mounting member 2 through a flexible force-variable elastic structure and a driven structure respectively; the flexible force-variable elastic structure includes a central shaft 3, a spring mounting base 4 and a volute spiral spring 5, a first end of the central shaft 3 is detachably mounted with a fixing mounting member 2, a spring mounting base 4 is rotatably inserted on a central shaft 3, and at least one spring mounting groove 6 are disposed on the spring mounting base 4, the volute spiral spring 5 is installed in the spring mounting groove 6, a central end of the volute spiral spring 5 is connected with the central shaft 3, and the free end of the volute spiral spring 5 is in contact with the inner wall of the hollow metal rod 1.

Before assembly of the flexible force-variable elastic structure, the volute spiral spring 5 is bound with a binding rope tied at the outside; the volute spiral spring 5, central shaft 3 and spring mounting base 4 are combined into a separate mounting accessory. When assembling, after the spring mounting base 4 is aligned with the hollow metal rod 1 and the binding rope is shortened, the entire flexible force-variable elastic structure is inserted into the hollow metal rod 1.

The present invention utilizes the interaction force to realize the retracting and releasing functions; when the curtain fabric rises, the volute spiral spring 5 is released, and when the curtain fabric drops, the volute spiral spring 5 compresses to produce an interaction force between the volute spiral spring 5 and the hollow metal rod 1. During use, by simply pushing or pulling the curtain fabric to generate proper power, the volute spiral spring 5 generates deformation to exert a pressing force on the hollow metal rod 1, and the hollow metal rod 1 can rotate quietly and softly, and stop the intended position accurately, stably and easily without any rebound. The invention can realize the retraction of the curtain fabric by directly pulling the end of the curtain fabric by hand, without requiring the setting of a hand pulling cord or an electric lifting structure.

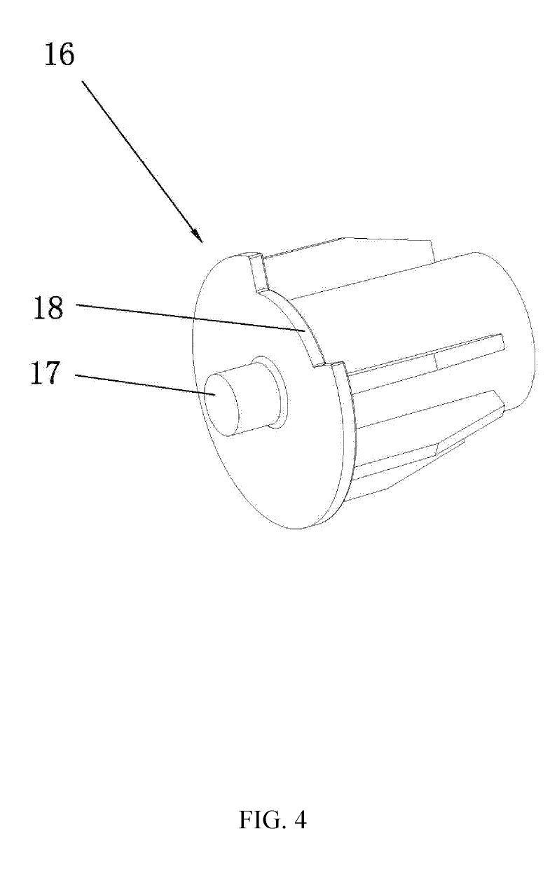

Referring to FIG.4, in one embodiment of the present invention, the driven structure is a plastic plug connector 16 with ribs protruding outwardly, the plastic plug connector 16 is transversely inserted into the hollow metal rod. When in use, the plastic plug connector 16 is horizontally inserted into a inlet end of the hollow metal rod 1, the plastic plug connector 16 is fixed in contact with the hollow metal rod 1 through a plurality of ribs, and the rib is in interference fit with the inner wall of the hollow metal rod 1. A rotating cylinder 17 is provided convexly on the side where the plastic plug connector 16 is connected with the fixing mounting member 2, a circular hole 7 is correspondingly disposed at the center of the fixing mounting member 2, the rotating cylinder 17 is inserted into the circular hole 7, and the hollow metal rod 1 rotates relative to the fixing mounting member 2 through the rotating cylinder 17.

In addition, as another embodiment, when the length and weight of the curtain fabric used are large, the flexible force-variable elastic structure can be installed on both ends of the hollow metal rod 1, the plastic plug connector 16 can be replaced by the flexible force-variable elastic structure; a reverse force will be generated at both ends of the hollow metal rod 1, broadening the applications of the curtain fabric retractable device.

Further, a limiting notch 18 is provided on the plastic plug connector 16 for preventing self-rotation, and a limiting bar 10 matching with the limiting notch 18 is provided inside the hollow metal rod 1, a limiting slot 11 matching with the limiting bar 10 is provide on the spring mounting base 4. When the spring mounting base 4 is mounted, the combined mounting is achieved quickly by the guidance of the limiting bar 10 and limiting slot 11. In addition, the limiting bar 10 can match with the limiting slot 11, to prevent self-rotation of the spring mounting base 4. A curtain fabric insertion slot 19 is formed between the limiting bar 10 and the hollow metal rod 1, and an elongated opening is provided on the hollow metal rod 1 corresponding to the curtain fabric insertion slot 19 for the curtain fabric to pass through. When the curtain fabric is installed, the installation side of the curtain fabric is inserted from the side of the curtain fabric insertion slot 19, so that the user does not need to remove the plastic plug connector 16 to replace the curtain fabric.

In one embodiment of the present invention, two spring mounting grooves 6 are juxtaposed on the spring mounting base 4, two spring mounting grooves 6 are formed by three partition plates 8; the outer side of the partition plate 8 is provided with a transverse connecting plate 9, and the three partition plates 8 are connected with the spring mounting base 4 integrally through a transverse connecting plate 9. The volute spiral spring 5 is separated by the partition plate 8, to avoid the interference each other. The retraction capability of flexible force-variable elastic structure is mainly determined by the recovery capability of volute spiral spring 5. The larger the recovery force generated by the deformation of volute spiral spring 5, the longer or wider the curtain fabric that is installed on hollow metal rod 1. Therefore, two spring mounting base 4 are juxtaposed on the spring mounting base 4, to expand its application scope.

Further, the end of the spring mounting base 4 may also be provided with a snap hole for snap-fitting, one additional partition plate 8 is inserted in the snap hole, and one spring mounting groove 6 is added, so that one more volute spiral spring 5 can be installed, to further enhance the elastic force of flexible force-variable elastic structure.

A strip hole 12 is radially opened on the central shaft 3, and the central end of the volute spiral spring 5 is snapped and fixed into the strip hole 12. The strip hole 12 can facilitate the winding of the volute spiral spring 5, improving the production efficiency.

Further, a cross-shaped insertion slot 13 is provided at one end of the central shaft 3 connected to the fixing mounting member 2, and a “ [symbol] ” shaped plug piece (not shown in the figure) is provided inside the fixing mounting member 2, and through mutually connecting the cross-shaped insertion slot 13 and the “ [symbol] ” shaped plug piece, the central shaft 3 is connected and assembled with the fixing mounting member 2, so that the central shaft 3 cannot rotate; when deformation of the volute spiral spring 5 occurs, its center does not self-rotate, to effectively ensure the stable force of the volute spiral spring 5.

A fixed top plate 14 made of aluminum is provided at the top of two fixing mounting members 2, the fixed top plate 14 is provided with a rectangular insertion slot, the fixing mounting member 2 is provided with a plug plate 15 corresponding to the rectangular insertion slot, by inserting the plug plate 15 into the rectangular insertion slot, the fixed top plate 14 is assembled with the fixing mounting member 2 at both ends to form a “ [symbol] ” shaped mounting base, with better supporting force. The hollow metal rod 1 and the fixed top plate 14 are made of aluminum; users can perform DIY cutting and installation according to the width of the curtain.

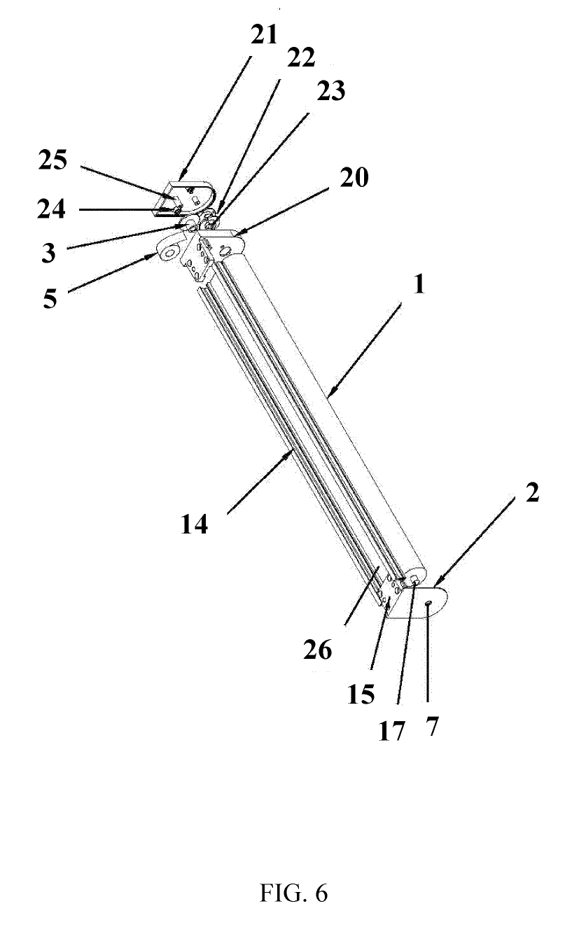

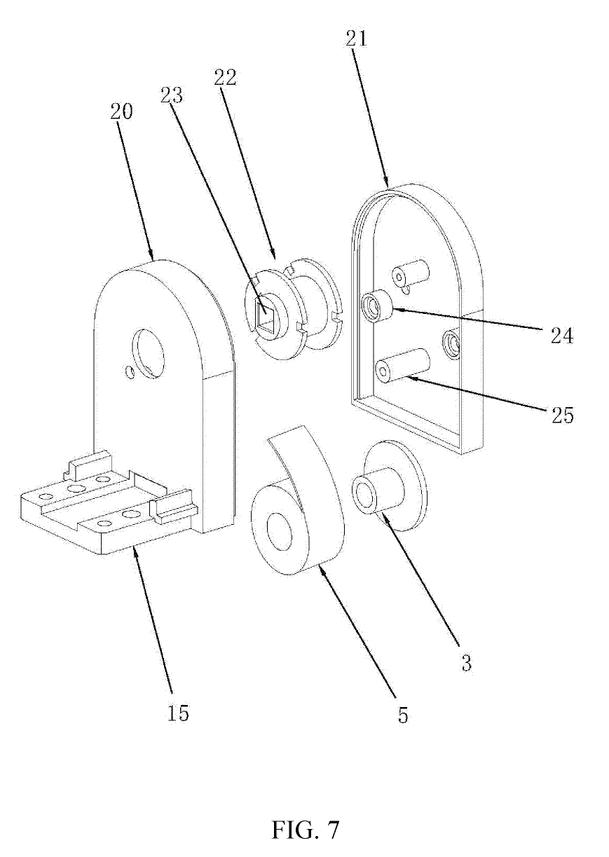

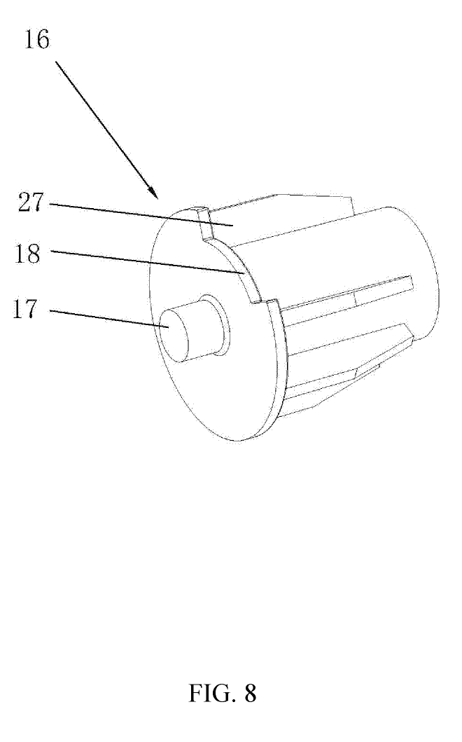

Yet another embodiment of the present invention is described in FIGS. 6 to 8, and further described in details herein. Said embodiment provides the curtain fabric retractable device, including the hollow metal rod 1 for winding the curtain fabric. The first end of the hollow metal rod 1 is provided with the fixing mounting member 2, and the second end is provided with a rotating control structure based on the contraction and release of the volute spiral spring. The hollow metal rod 1 can be installed between the fixing mounting member 2 and the rotating control structure through rotation. The rotating control structure includes a control mechanism shell, in which a rotating wheel 22 driven by the hollow metal rod 1, the central shaft 3 and the volute spiral spring 5 installed on the central shaft 3 are installed. The central shaft 3 is located below the rotating wheel 22, and a tail end of a outermost ring of the volute spiral spring 5 is connected to one side of the rotating wheel 22.

In use, when a user gently pulls lower part of curtain fabric with her hand, the curtain fabric will drive the hollow metal rod 1 to rotate; as long as the curtain fabric is pulled, the rotating wheel 22 will immediately rotate and pull the volute spiral spring 5, and a reversed applied force will be generated. Based on the principle of interaction force, as long as users stop pulling the curtain fabric, it will stop at the intended position accurately, steadily and easily, without springback; so there is no need to set a hand rope or an electric lifting structure, and the contraction and release of curtain fabric can be realized when users pull the tail end of the curtain fabric with hand gently.

The fixed top plate 14 is further arranged between the fixing mounting member 2 and the rotating control structure. The control mechanism shell includes a left shell 20 and a right shell 21. A first side of the left shell 20 is connected to the fixed top plate 14 as a combination, and a second side is combined with the right shell 21 as a holding space; a locating column 24 and a fixed connecting column 25 that are used to install the rotating wheel 22 and the central shaft 3 are arranged on the right shell 21, and the locating column 24 and the fixed connecting column 25 are integrated with the right shell 21 as an organic whole. The rotating wheel 22, the central shaft 3 and the volute spiral spring 5 are all positioned and installed on the locating column 24, and a screw is used to fasten the left shell 20 and the right shell 21 as an organic whole, forming the rotating control structure.

Further, a rectangular slot 26 is arranged on the fixed top plate 14, and the plug plate 15 used to cooperate with the rectangular slot 26 for installation is arranged on the fixing mounting member 2 and the left shell 20 respectively. User only needs to insert the plug plate 15 into the rectangular slot 26, and use a screw to tighten, then a mounting bracket can be formed.

The plastic plug connector 16 is inserted into the second side of the hollow metal rod 1 that is connected to the fixing mounting member 2, the rotating cylinder 17 is arranged on an bulge of the plastic plug connector 16, the circular hole 7 is arranged correspondingly at the center of the fixing mounting member 2, and the rotating cylinder 17 is inserted into the circular hole 7. The hollow metal rod 1 rotates relative to the fixing mounting member 2 via the rotating cylinder 17. Further, a plug stiffener 27 that fits the inner wall of the hollow metal rod 1 is formed on a outer wall of the plastic plug connector 16, and the limiting notch 18 for preventing autorotation is arranged on the plastic plug connector 16. In use, insert the plastic plug connector 16 into the port of the hollow metal rod 1, and the plug stiffener 27 matches with the inner wall of the hollow metal rod 1 in an interference fit manner, so the fixation and installation are simple and convenient; and a limiting bar 10 that fits the limiting notch 18 is arranged inside the hollow metal rod 1. When assembling the plastic plug connector 16, correspondingly insert the limiting notch 18 and the limiting bar 10, then accurate, convenient and rapid installation can be achieved, and autorotation of the hollow metal rod 1 can be avoided effectively.

Further, the curtain fabric insertion slot 19 is formed between the limiting bar 10 and the hollow metal rod 1, and a strip-shaped opening is arranged at the position on the hollow metal rod 1 that corresponds to the curtain fabric insertion slot 19 for curtain fabric to pass through. When installing the curtain fabric, inserting the installation end of the curtain fabric into the curtain fabric insertion slot 19 from one side, without need to disassemble the plastic plug connector 16 that has been installed.

A square hole 23 for connecting the hollow metal rod 1 is arranged in the middle of the rotating wheel 22, and a second plastic plug connector (not shown in the figure) is inserted into one side of the hollow metal rod 1 to be connected to the rotating wheel 22. The structure of the second plastic plug connector is basically the same as that of the plastic plug connector 16, and the difference is that the combination and connection between the rotating wheel 22 and the hollow metal rod 1 can be completed after a square connecting block is arranged on the bulge of the second plastic plug connector and the square connecting block is inserted into the square hole 23. During rotation, the synchronous transmission of power can be achieved.

The foregoing descriptions are merely exemplary embodiments of the present invention, but not intended to limit the present invention in any form. Although the present invention is disclosed by preferred embodiments, it is not intended to limit the present invention. Technicians skilled in the art can make some changes or modifications made equivalent to the technical contents disclosed herein without departing from the technical solution of the present invention. All technical contents without departing from the technical solution of the present invention, and any simple modifications, equivalent changes and modifications made to the above embodiments will fall within the scope of the protection of the present invention.

What is claimed is:

1. A curtain fabric retractable device, comprising a hollow metal rod for winding the curtain fabric, one end of the hollow metal rod is provided with a fixing mounting member, and the other end is provided with a rotating control structure based on the contraction and release of a volute spiral spring, the hollow metal rod can be installed between the fixing mounting member and the rotating control structure through rotation, the rotating control structure comprises a control mechanism shell, in which a rotating wheel driven by the hollow metal rod, a central shaft and a volute spiral spring installed on the central shaft are installed, the central shaft is located below the rotating wheel, and the tail end of the outermost ring of the volute spiral spring is connected to one side of the rotating wheel.

2. The curtain fabric retractable device according to claim 1, wherein a fixed top plate is further arranged between the fixing mounting member and the rotating control structure, the control mechanism shell comprises a left shell and a right shell, one side of the left shell is connected to the fixed top plate as a combination, and the other side is combined with the right shell as a holding space; a locating column and a fixed connecting column that are used to install the rotating wheel and the central shaft are arranged on the right shell, and the locating column and the fixed connecting column are integrated with the right shell as an organic whole.

3. The curtain fabric retractable device according to claim 2, wherein a rectangular slot is arranged on the fixed top plate, and a plug plate used to cooperate with the rectangular slot for installation is arranged on the fixing mounting member and the left shell respectively.

4. The curtain fabric retractable device according to claim 1, wherein a plastic plug connector is inserted into one side of the hollow metal rod that is connected to the fixing mounting member, a rotating cylinder is arranged on the bulge of the plastic plug connector, a circular hole is arranged correspondingly at the center of the fixing mounting member, and the rotating cylinder is inserted into the circular hole.

5. The curtain fabric retractable device according to claim 4, wherein a plug stiffener that fits the inner wall of the hollow metal rod is formed on the outer wall of the plastic plug connector, and a limiting notch for preventing autorotation is arranged on the plastic plug connector, and a limiting bar that fits the limiting notch is arranged inside the hollow metal rod.

6. The curtain fabric retractable device according to claim 5, wherein a curtain fabric insertion slot is formed between the limiting bar and the hollow metal rod, and a strip-shaped opening is arranged at the position on the hollow metal rod that corresponds to the curtain fabric insertion slot for curtain fabric to pass through.

7. The curtain fabric retractable device according to claim 4, wherein a square hole for connecting the hollow metal rod is arranged in the middle of the rotating wheel, a second plastic plug connector is inserted into one side of the hollow metal rod to be connected to the rotating wheel, a square connecting block is arranged on the bulge of the second plastic plug connector, and the square connecting block is inserted into the square hole.
